(19) United States
(12) Patent Application Publication
(10) Pub. No.: US 2026/0118296 A1
(43) Pub. Date: Apr. 30, 2026

(54) PHOTOELECTRON SPECTROSCOPY METHOD AND APPARATUS, ELECTRONIC DEVICE, AND STORAGE MEDIUM

(71) Applicant: THE HONG KONG UNIVERSITY OF SCIENCE AND TECHNOLOGY (GUANGZHOU), Guangzhou City (CN)

(72) Inventors: Tongyi ZHANG, Guangzhou City (CN); Bin CAO, Guangzhou City (CN); Lutao WENG, Guangzhou City (CN); Yuxiao HOU, Guangzhou City (CN); Bolin ZHENG, Guangzhou City (CN)

(21) Appl. No.: 19/082,589

(22) Filed: Mar. 18, 2025

(30) Foreign Application Priority Data
Oct. 28, 2024 (CN) 202411515246.2

(51) Int. Cl. G01N 23/2273

(52) U.S. Cl. CPC G01N 23/2273

(57) ABSTRACT

A photoelectron spectroscopy method includes: performing photoelectron spectrum detection on a target sample to obtain an initial photoelectron spectrum; selecting spectrum data points according to the initial photoelectron spectrum to obtain a photoelectron spectrum data point sequence; performing a first model parameter update on a preset initial photoelectron spectrum fitting model according to a preset expectation-maximization algorithm and the photoelectron spectrum data point sequence to obtain a first photoelectron spectrum fitting model; acquiring a target quantum effect constraint for the target sample; performing a second model parameter update on the first photoelectron spectrum fitting model according to a preset central field approximation relation and the target quantum effect constraint to obtain a second photoelectron spectrum fitting model; and performing spectrum fitting on the photoelectron spectrum data point sequence according to the second photoelectron spectrum fitting model to obtain a target photoelectron spectrum.

### CROSS-REFERENCE TO RELATED APPLICATION

This application is based on and claims the benefit of priority from Chinese Patent Application No. 2024115152462, filed on Oct. 28, 2024, the entirety of which is incorporated by reference herein.

### TECHNICAL FIELD

This application relates to the technical field of surface material characterization, and in particular, to a photoelectron spectroscopy method and apparatus, an electronic device, and a storage medium.

### BACKGROUND

X-ray photoelectron spectroscopy (XPS), also known as ESCA (Electron Spectroscopy for Chemical Analysis), is a technology that uses X-rays to irradiate the surface of a sample and measures emitted photoelectrons to obtain a photoelectron spectrum. The photoelectron spectrum provides insights into the sample's physical and chemical properties.

The current methods for analyzing photoelectron spectra, including determining the peak shape and peak area of spectral lines, lack sufficient accuracy. For example, due to the varying scattering intensities of photoelectrons emitted from the sample surface, the measured photoelectron spectrum often contains noise. Additionally, the decomposed peak area by existing analysis methods do not align with the quantum constraints dictated by quantum mechanics.

Therefore, improving the accuracy of the photoelectron spectrum analysis results has become an urgent technical challenge needs to be solved.

### SUMMARY

A main objective of embodiments of the present disclosure is to provide a photoelectron spectroscopy method and apparatus, an electronic device, and a storage medium, to improve the authenticity and accuracy of the photoelectron spectrum and obtain a photoelectron spectrum conforming to the constraints of the quantum effect.

To achieve the above objective, in accordance with a first aspect of the present disclosure, an embodiment provides a photoelectron spectroscopy method, including:
performing photoelectron spectrum detection on a target sample to obtain an initial photoelectron spectrum;
selecting spectrum data points according to the initial photoelectron spectrum to obtain a photoelectron spectrum data point sequence;
performing a first model parameter update on a preset initial photoelectron spectrum fitting model according to a preset expectation-maximization algorithm and the photoelectron spectrum data point sequence to obtain a first photoelectron spectrum fitting model;
acquiring a target quantum effect constraint for the target sample;
performing a second model parameter update on the first photoelectron spectrum fitting model according to a preset central field approximation relation and the target quantum effect constraint to obtain a second photoelectron spectrum fitting model; and
performing spectrum fitting on the photoelectron spectrum data point sequence according to the second photoelectron spectrum fitting model to obtain a target photoelectron spectrum.

In some embodiments, the target quantum effect constraint includes a peak pairwise constraint condition and a peak attribute ratio threshold; and
performing a second model parameter update on the first photoelectron spectrum fitting model according to a preset central field approximation relation and the target quantum effect constraint to obtain a second photoelectron spectrum fitting model includes:
   performing photoelectron peak fitting on the photoelectron spectrum data point sequence according to the first photoelectron spectrum fitting model to obtain at least two target photoelectron peaks;
   performing peak pairing detection on any two of the target photoelectron peaks according to the peak pairwise constraint condition to obtain a first target photoelectron peak and a second target photoelectron peak;
   determining a peak attribute value ratio according to an attribute value of the first target photoelectron peak and an attribute value of the second target photoelectron peak; and
   performing a model parameter update on the first photoelectron spectrum fitting model according to the central field approximation relation to obtain the second photoelectron spectrum fitting model in response to the peak attribute value ratio being not equal to the peak attribute ratio threshold.

In some embodiments, model parameters of the first photoelectron spectrum fitting model include an initial peak intensity parameter and an initial peak position parameter; the peak attribute value ratio includes a peak intensity ratio, the peak attribute ratio threshold includes a peak intensity ratio threshold, and the central field approximation relation includes a central field approximation split peak relation; and
performing a model parameter update on the first photoelectron spectrum fitting model according to the central field approximation relation to obtain the second photoelectron spectrum fitting model in response to the peak attribute value ratio being not equal to the peak attribute ratio threshold includes:
   in response to the peak intensity ratio being not equal to the peak intensity ratio threshold, determining a first peak intensity constraint relation and a peak position constraint relation according to the central field approximation split peak relation;
   determining a first peak intensity constraint factor according to the first peak intensity constraint relation, a total angular quantum number of the first target photoelectron peak, and a total angular quantum number of the second target photoelectron peak;
   updating the initial peak intensity parameter according to the first peak intensity constraint factor to obtain a first target peak intensity parameter;
   determining a peak position constraint factor according to the peak position constraint relation, a principal quantum number, an angular quantum number, and the total angular quantum number of the first target photoelectron peak, and a principal quantum number, an angular quantum number, and the total angular quantum number of the second target photoelectron peak;
   updating the initial peak position parameter according to the peak position constraint factor to obtain a target peak position parameter; and
   determining the second photoelectron spectrum fitting model according to the first target peak intensity parameter and the target peak position parameter.

In some embodiments, model parameters of the first photoelectron spectrum fitting model include an initial peak intensity parameter; the peak attribute value ratio further includes a peak area ratio, the peak pairwise constraint condition further includes a satellite peak constraint condition, the peak attribute ratio threshold further includes a peak area ratio threshold, and the central field approximation relation further includes a central field approximation satellite peak relation; and
performing a model parameter update on the first photoelectron spectrum fitting model according to the central field approximation relation to obtain the second photoelectron spectrum fitting model in response to the peak attribute value ratio being not equal to the peak attribute ratio threshold further includes:
   in response to the peak area ratio being not equal to the peak area ratio threshold, determining a second peak intensity constraint relation according to the central field approximation satellite peak relation;
   determining a second peak intensity constraint factor according to the second peak intensity constraint relation, a peak area of the first target photoelectron peak, and a peak area of the second target photoelectron peak;
   updating the initial peak intensity parameter according to the second peak intensity constraint factor to obtain a second target peak intensity parameter; and
   determining the second photoelectron spectrum fitting model according to the second target peak intensity parameter.

In some embodiments, the initial photoelectron spectrum has initial photoelectron peaks; and selecting spectrum data points according to the initial photoelectron spectrum to obtain a photoelectron spectrum data point sequence includes:
dividing spectrum data points according to a spectral line of the initial photoelectron spectrum to obtain at least two initial background data points and at least two initial non-background data points, where each of the initial background data points and each of the initial non-background data points has an energy value and an intensity value;
performing background spectrum curve fitting on at least two of the initial background data points according to a preset Gaussian random process function to obtain a background spectrum curve;
performing a first intensity value update on the intensity value of each of the initial non-background data points according to the energy value and the intensity value of each of the initial background data points and the energy value of each of the initial non-background data points to obtain corresponding target non-background data points;
performing a second intensity value update on the intensity value of each of the initial background data points according to the background spectrum curve to obtain corresponding target background data points, where an intensity value of each of the target background data point is less than an intensity value of the respective initial background data point; and
performing data point integration according to the target non-background data points and the target background data points to obtain the photoelectron spectrum data point sequence.

In some embodiments, performing a first intensity value update on the intensity value of each of the initial non-background data points according to the energy value and the intensity value of each of the initial background data points and the energy value of each of the initial non-background data points to obtain corresponding target non-background data points includes:
performing a background intensity calculation according to the energy value and the intensity value of each of the initial background data points and the energy value of each of the initial non-background data points to obtain a background intensity vector; and
performing the first intensity value update on the intensity value of each of the initial non-background data points according to the background intensity vector to obtain the target non-background data points.

In some embodiments, dividing spectrum data points according to a spectral line of the initial photoelectron spectrum to obtain at least two initial background data points and at least two initial non-background data points includes:
selecting spectrum data points from the initial photoelectron spectrum to obtain a plurality of initial spectrum data points; and
dividing each of the initial spectrum data points according to a trough of the spectral line of the initial photoelectron spectrum to obtain the at least two initial background data points and the at least two initial non-background data points, where the initial background data points are located at the trough of the spectral line.

To achieve the above objective, in accordance with a second aspect of the present disclosure, an embodiment provides a photoelectron spectroscopy apparatus, including:
a photoelectron spectrum acquisition module, configured for performing photoelectron spectrum detection on a target sample to obtain an initial photoelectron spectrum;
a data point selection module, configured for selecting spectrum data points according to the initial photoelectron spectrum to obtain a photoelectron spectrum data point sequence;
a first model parameter updating module, configured for performing a first model parameter update on a preset initial photoelectron spectrum fitting model according to a preset expectation-maximization algorithm and the photoelectron spectrum data point sequence to obtain a first photoelectron spectrum fitting model;
a quantum effect constraint acquisition module, configured for acquiring a target quantum effect constraint for the target sample;
a second model parameter updating module, configured for performing a second model parameter update on the first photoelectron spectrum fitting model according to a preset central field approximation relation and the target quantum effect constraint to obtain a second photoelectron spectrum fitting model; and
a spectrum fitting module, configured for performing spectrum fitting on the photoelectron spectrum data point sequence according to the second photoelectron spectrum fitting model to obtain a target photoelectron spectrum.

To achieve the above objective, in accordance with a third aspect of the present disclosure, an embodiment provides an electronic device, including a memory and a processor, where the memory is configured for storing a computer program which, when executed by the processor, causes the processor to implement the method in accordance with the first aspect.

To achieve the above objective, in accordance with a fourth aspect of the present disclosure, an embodiment provides a computer-readable storage medium, storing a computer program which, when executed by a processor, causes the processor to implement the method in accordance with the first aspect.

According to the photoelectron spectroscopy method and apparatus, the electronic device, and the storage medium provided in the present disclosure, after a photoelectron spectrum data point sequence corresponding to an initial photoelectron spectrum is obtained and an initial photoelectron spectrum fitting model is updated according to an expectation-maximization algorithm and the photoelectron spectrum data point sequence to obtain a first photoelectron spectrum fitting model, a target quantum effect constraint for a target sample is further acquired, and a second model parameter update is performed on the first photoelectron spectrum fitting model according to a preset central field approximation relation and the target quantum effect constraint to obtain a second photoelectron spectrum fitting model. In this way, it is ensured that the target photoelectron spectrum obtained through fitting using the second photoelectron spectrum fitting model conforms to the target quantum effect constraint for the target sample, thereby improving the accuracy of photoelectron spectroscopy.

### BRIEF DESCRIPTION OF DRAWINGS

FIG. 1 is a flowchart of a photoelectron spectroscopy method according to an embodiment of the present disclosure;

FIG. 2 is a flowchart of step 102 in FIG. 1;

FIG. 3 is a flowchart of step 201 in FIG. 2;

FIG. 4 is a schematic diagram of an initial photoelectron spectrum according to an embodiment of the present disclosure;

FIG. 5 is a schematic diagram of an initial photoelectron spectrum according to another embodiment of the present disclosure;

FIG. 6 is a flowchart of step 203 in FIG. 2;

FIG. 7 is a flowchart of step 105 in FIG. 1;

FIG. 8 is a flowchart of step 504 in FIG. 7 according to an embodiment of the present disclosure;

FIG. 9 is a flowchart of step 504 in FIG. 7 according to another embodiment of the present disclosure;

FIG. 10 is a schematic structural diagram of a photoelectron spectroscopy apparatus according to an embodiment of the present disclosure; and

FIG. 11 is a schematic structural diagram of hardware of an electronic device according to an embodiment of the present disclosure.

### DETAILED DESCRIPTION

To make the objectives, technical schemes, and advantages of the present disclosure clear, the present disclosure is described in further detail in conjunction with accompanying drawings and embodiments. It should be understood that the specific embodiments described herein are merely used for illustrating the present disclosure, and are not intended to limit the present disclosure.

It is to be noted, although functional modules have been divided in the schematic diagrams of apparatuses and logical orders have been shown in the flowcharts, in some cases, the modules may be divided in a different manner, or the steps shown or described may be executed in an order different from the orders as shown in the flowcharts. The terms such as “first”, “second” and the like in the description, the claims, and the accompanying drawings are used to distinguish similar objects, and are not necessarily used to describe a specific sequence or a precedence order.

Unless otherwise defined, meanings of all technical and scientific terms used in this description are the same as those usually understood by those having ordinary skills in the art to which the present disclosure belongs. Terms used in this description are merely intended to describe objectives of the embodiments of the present disclosure, but are not intended to limit the present disclosure.

First, several terms involved in the present disclosure are explained.

X-ray photoelectron spectroscopy (XPS): It is also known as Electron Spectroscopy for Chemical Analysis (ESCA), and is a surface analysis technique. In X-ray photoelectron spectroscopy, a sample is irradiated with X-rays to excite out electrons of atoms or molecules in the sample, such that photoelectrons are emitted from the surface of the sample. The electrons excited by photons are called photoelectrons, and these photoelectrons mainly come from the inner shell of atoms on the surface of the sample. The energy of photoelectrons can be measured, and a photoelectron spectrum can be obtained with the kinetic energy of photoelectrons as an abscissa and the relative intensity of photoelectrons as an ordinate, to obtain physical and chemical information of the sample, such as the chemical composition of the sample.

Central field approximation: It is a method of treating every electron in an atom as moving in a potential field that is spherically symmetrical to the nucleus, and is used for calculating the energy of the electron.

Background signal: It refers to other signals that exist in addition to the photoelectronic signal of the sample during the XPS measurement process. These signals mainly come from the energy loss of photoelectrons during the escape process, such as the energy loss due to inelastic collisions. These energy losses affect the measured values of photoelectron binding energy, and lead to the formation of background signals.

Split peaks: They are a pair of photoelectron peaks caused by the spin-orbit coupling of electrons. In photoelectron spectroscopy (such as XPS), due to the spin-orbit coupling effect of electrons, energy levels with the same principal quantum number but different spins and orbital angular momenta are subjected to energy splitting, which leads to the formation of two or more peaks in the spectrum. Such peaks are called split peaks.

Satellite peaks: They refer to other low-energy spectral lines produced by the excitation of atoms or molecules in addition to the main spectral line (also called the main peak) during spectral analysis. These satellite peaks are low-energy spectral lines adjacent to the main peaks, which are produced due to the impact of multiple factors such as multiplet splitting (splitting of energy levels), shake-up (electrons deviate from their original orbits due to external forces) and shake-off (electrons are completely stripped from atoms or molecules) on the transition of atoms or molecules from high energy levels to low energy levels.

Artificial Intelligence (AI): It is a technology that researches and develops theories, methods, technologies, and application systems for simulating, extending, and expanding human intelligence. Research in this field includes robotics, speed recognition, image recognition, natural language processing, etc.

Machine learning: It is a branch of AI that enables computer systems to automatically learn and improve their performance using data and algorithms. A machine learning model can be trained with sample data to make predictions or decisions.

A photoelectron spectroscopy method and apparatus, an electronic device, and a storage medium provided in the embodiments of the present disclosure will be described in detail through the following embodiments. The photoelectron spectroscopy method in the embodiments of the present disclosure is described first.

In the embodiments of the present disclosure, related data may be acquired and processed based on the AI technology. AI is a theory, method, technology, and application system that uses a digital computer or a machine controlled by the digital computer to simulate, extend, and expand human intelligence, perceive an environment, acquire knowledge, and use knowledge to obtain an optimal result.

The photoelectron spectroscopy method provided in the embodiments of the present disclosure may be applied to a terminal device or a server, or may be software running in a terminal device or a server.

The present disclosure may be used in a wide variety of general purpose or special purpose computer system environments or configurations, for example, personal computers (PCs), server computers, handheld or portable devices, tablet-type devices, multiprocessor systems, microprocessor-based systems, set-top boxes, programmable consumer electronic devices, network PCs, midrange computers, mainframe computers, distributed computing environments including any of the above systems or devices, etc.

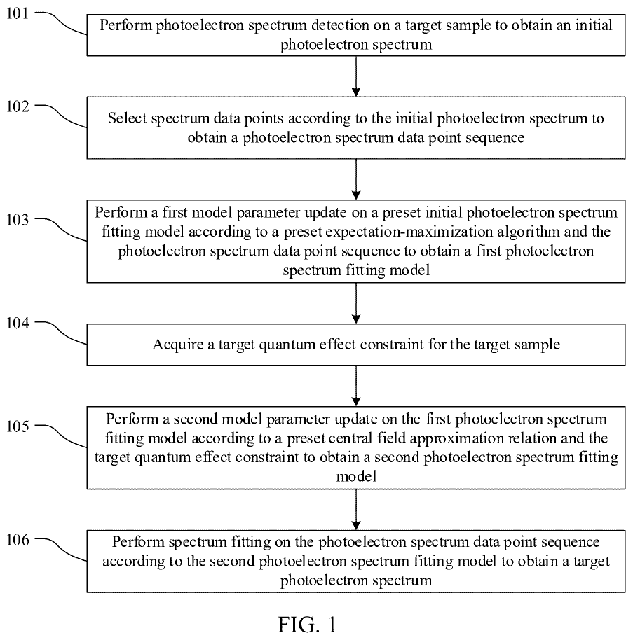

FIG. 1 is an optional flowchart of a photoelectron spectroscopy method according to an embodiment of the present disclosure. The method in FIG. 1 may include, but not limited to, the following steps 101 to 106.

At 101, photoelectron spectrum detection is performed on a target sample to obtain an initial photoelectron spectrum.

At 102, spectrum data points are selected according to the initial photoelectron spectrum to obtain a photoelectron spectrum data point sequence.

At 103, a first model parameter update is performed on a preset initial photoelectron spectrum fitting model according to a preset expectation-maximization algorithm and the photoelectron spectrum data point sequence to obtain a first photoelectron spectrum fitting model.

At 104, a target quantum effect constraint for the target sample is acquired.

At 105, a second model parameter update is performed on the first photoelectron spectrum fitting model according to a preset central field approximation relation and the target quantum effect constraint to obtain a second photoelectron spectrum fitting model.

At 106, spectrum fitting is performed on the photoelectron spectrum data point sequence according to the second photoelectron spectrum fitting model to obtain a target photoelectron spectrum.

Beneficial effects of the embodiments of the present disclosure include, but not limited to, the following effects. After a photoelectron spectrum sequence corresponding to an initial photoelectron spectrum is obtained, an initial photoelectron spectrum fitting model is updated according to an expectation-maximization algorithm and the photoelectron spectrum data point sequence to obtain a first photoelectron spectrum fitting model under the constraints of quantum effect. A second model parameter update is performed on the first photoelectron spectrum fitting model according to the central field approximation relation and the target quantum effect constraint to obtain a second photoelectron spectrum fitting model. In this way, it is ensured that the results of the second photoelectron spectrum fitting model conforms to the target quantum effect constraint, thereby improving the reliability and authenticity of the photoelectron spectroscopy analysis method.

In some embodiments, step 101 may include the following operations. (1) Pretreatment of the target sample. Appropriate pretreatment may be carried out according to experimental requirements. For example, the target sample may be polished and cleaned. (2) Placement of the target sample in a vacuum system. The vacuum system has a sample cell for holding the target sample. In the vacuum system, equipment such as an X-ray source and a photoelectron spectrometer may also be installed. (3) Deployment of the X-ray source. The X-ray source may be adjusted according to preset position information to ensure that an X-ray beam emitted from the X-ray source irradiates sampling points on the surface of the target sample. Alternatively, an angle between the X-ray source and the target sample may be adjusted to ensure that the surface of the target sample is perpendicular to X-rays emitted from the X-ray source. The X-ray source may also be configured according to a preset X-ray energy value to excite electrons on the surface of the target sample to generate photoelectrons. A monochromatic X-ray source may be used. (4) Initialization of instrument parameters of the photoelectron spectrometer. The photoelectron spectrometer is configured for acquiring data to generate a photoelectron spectrum. Before the acquisition of data, it is necessary to initialize instrument parameters such as energy resolution and the number of sampling points of the photoelectron spectrometer. (5) Measurement of the target sample with the X-ray source and the photoelectron spectrometer to obtain an initial photoelectron spectrum. The initial photoelectron spectrum may be obtained by performing multiple measurements at different sampling points on the surface of the target sample to obtain initial measurement spectra and then averaging the initial measurement spectra. As such, the accuracy of spectrum measurement is improved. The initial photoelectron spectrum may also be acquired by other means, and the present disclosure is not limited thereto.

It should be noted that the target sample is a condensed substance, including solid and liquid substances. In some embodiments, the target sample may be a sample of a metal (iron, copper, etc.) or a semiconductor, such as divalent copper. In another embodiment, the target photoelectron spectrum corresponding to the target sample may be a 2p orbital photoelectron spectrum of divalent copper.

It should be noted that photoelectron spectra (such as the initial photoelectron spectrum and the target photoelectron spectrum) have spectral lines, and the spectral lines have peaks and troughs. The photoelectron peak is the peak of the spectral line. The photoelectron peak has peak attributes, such as peak position, peak width, peak shape, peak area (also called integrated intensity), and other attributes. The abscissa of the photoelectron spectrum is energy value, and the ordinate of the photoelectron spectrum is intensity value. The energy value is used for characterizing electron binding energy of a photoelectron, and the intensity value is used for characterizing a relative intensity of the photoelectron. Each intensity value corresponds to one energy value.

In some embodiments, in step 102, the photoelectron spectrum data point sequence includes a plurality of spectrum data points, which are points on the spectral line of the initial photoelectron spectrum. The photoelectron spectrum data point sequence is a data point sequence obtained by removing a background signal. In another embodiment, after a background data point sequence of the photoelectron spectrum is obtained, the background data point sequence of the photoelectron spectrum may be fitted according to a Gaussian random process, to obtain a background curve of the entire spectrum (initial photoelectron spectrum).

In some embodiments, in step 103, the initial photoelectron spectrum fitting model is a machine learning model. In some embodiments, it should be noted that in the related art, the photoelectron spectrum may be solved by a least square method, but this method has low spectrum analysis efficiency and is likely to fall into a local optimal solution, and the authenticity of the photoelectron spectrum obtained by this method is low. In an embodiment of the present disclosure, the initial photoelectron spectrum fitting model is updated according to the expectation-maximization algorithm to obtain the target photoelectron spectrum, such that the efficiency of spectrum analysis and the authenticity of the target photoelectron spectrum are improved.

In some embodiments, in step 104, the target quantum effect constraint is used for reflecting whether a peak parameter ratio relationship between two photoelectron peaks conforms to the theory of quantum mechanics. In an embodiment, for example, if the target sample is a metallic titanium sample, the initial photoelectron spectrum is a 2p orbital photoelectron spectrum of titanium (Ti), and two photoelectron peaks in the initial photoelectron spectrum are a pair of split peaks, the peak intensity ratio of the two photoelectron peaks should be 3:2 based on the theory of quantum mechanics. In another embodiment, if the two photoelectron peaks in the initial photoelectron spectrum of the metallic titanium sample are a pair of satellite peaks, the peak area ratio of the two photoelectron peaks should be 2:1 based on the theory of quantum mechanics.

In some embodiments, in step 105, it should be noted that in the related art, the spectral line of the photoelectron spectrum obtained through fitting may be matched with spectral line observed in the experiment, and peak parameters (such as peak position and peak intensity) of photoelectron peaks of the spectral line may be adjusted to update the photoelectron spectrum. However, this method is easily affected by data noise and scattering intensity, resulting in that the photoelectron spectrum does not well conform to the theory of quantum mechanics, or even violates the theory of quantum mechanics. For example, the photoelectron peaks of the spectral line of the photoelectron spectrum do not meet a constraint condition of split peaks. Considering the above technical problems, in the embodiments of the present disclosure, the first photoelectron spectrum fitting model is updated according to the central field approximation relation and the target quantum effect constraint to obtain the second photoelectron spectrum fitting model, to ensure that the target photoelectron spectrum output by the second photoelectron spectrum fitting model meets the target quantum effect constraint, thereby obtaining a target photoelectron spectrum meeting the target quantum effect constraint, and improving the authenticity of the spectrum analysis result.

In some embodiments, in step 106, peak fitting may be performed on the photoelectron spectrum data point sequence according to the second photoelectron spectrum fitting model to obtain a plurality of photoelectron peaks; then, spectrum fitting may be performed on the plurality of photoelectron peaks according to the second photoelectron spectrum fitting model to obtain the target photoelectron spectrum.

It should be noted that in the embodiments of the present disclosure, through the automatic spectrum fitting using the second photoelectron spectrum fitting model, photoelectron spectra can be analyzed with high throughput, to meet requirements in a scenario of large-scale photoelectron spectrum analysis in a high-throughput laboratory or robotic laboratory. High-throughput analysis of photoelectron spectra refers to the detection and photoelectron spectroscopy of a large number of samples.

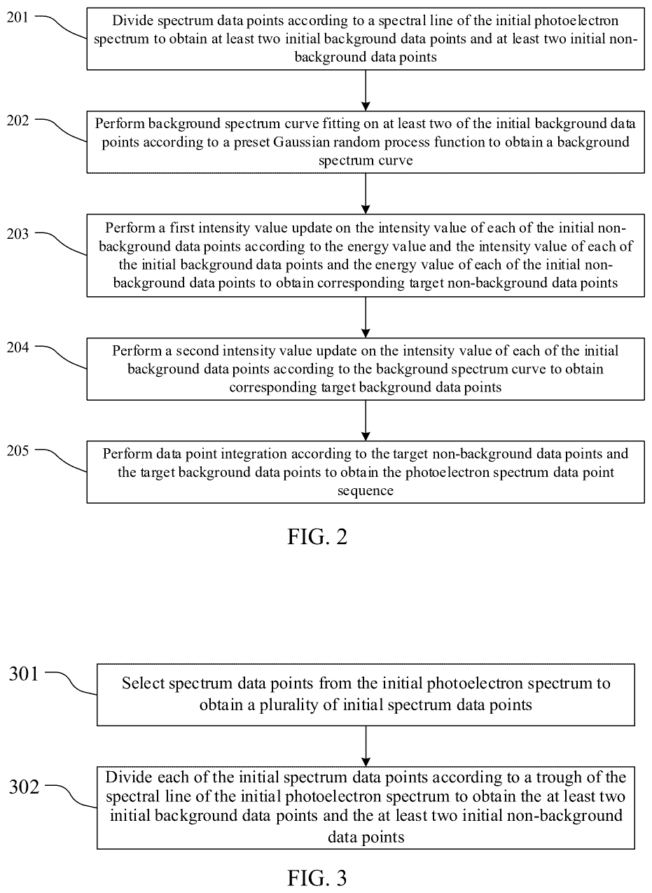

Referring to FIG. 2, in some embodiments, the initial photoelectron spectrum has initial photoelectron peaks. Step 102 may include, but not limited to, the following steps 201 to 205.

At 201, spectrum data points are divided according to a spectral line of the initial photoelectron spectrum to obtain at least two initial background data points and at least two initial non-background data points, where each of the initial background data points and each of the initial non-background data points has an energy value and an intensity value.

At 202, background spectrum curve fitting is performed on at least two of the initial background data points according to a preset Gaussian random process function to obtain a background spectrum curve.

At 203, a first intensity value update is performed on the intensity value of each of the initial non-background data points according to the energy value and the intensity value of each of the initial background data points and the energy value of each of the initial non-background data points to obtain corresponding target non-background data points.

At 204, a second intensity value update is performed on the intensity value of each of the initial background data points according to the background spectrum curve to obtain corresponding target background data points, where an intensity value of each of the target background data points is less than an intensity value of the respective initial background data point.

At 205, data point integration is performed according to the target non-background data points and the target background data points to obtain the photoelectron spectrum data point sequence.

It should be noted that in the process of photoelectron spectroscopy of the target sample, a background signal is present, which is an interference signal that affects the accuracy of photoelectron spectroscopy. For example, the background signal affects the intensity value of the spectral line, causing the intensity value to deviate from the real photoelectron intensity value. To eliminate the impact of the background signal of the target sample on the photoelectron spectrum, it is necessary to correct the photoelectron spectrum, i.e., to remove the background signal.

This embodiment has the following advantages. The initial background data points and the initial non-background data points are obtained through division according to the initial photoelectron spectrum, and the intensity values of the initial background data points and the initial non-background data points are updated respectively, to eliminate the impact of the background signal on the intensity values of the data points, thereby removing the background signal from the initial background data points and the initial non-background data points to obtain more accurate target background data points and target non-background data points. Then, the target non-background data points and the target background data points are integrated to obtain the photoelectron spectrum data point sequence, such that the target photoelectron spectrum can be obtained subsequently by performing spectrum fitting according to the photoelectron spectrum data point sequence, thereby improving the accuracy of analysis of the target photoelectron spectrum.

In some embodiments, in step 201, a difference between the initial background data point and the initial non-background data point lies in that the initial background data point is located at the trough of the spectral line and the initial non-background data point is located at the peak (i.e., photoelectron peak) of the spectral line.

In some embodiments, in step 202, the initial background data points may be fitted using a Gaussian Random Process function to obtain a background spectrum curve. The background spectrum curve overlaps with or is close to a part with the lowest spectral line intensity values of the initial photoelectron spectrum. A suitable method for fitting the background spectrum curve may be selected according to requirements, which is not limited in the embodiments of the present disclosure.

In some embodiments, in step 203, an intensity value of the target non-background data point is less than or equal to an intensity value of the initial non-background data point. Step 203 may alternatively be calculating a difference between the intensity value of each of the initial background data points and an intensity value of a corresponding data point on the background spectrum curve to obtain the corresponding target non-background data point. The corresponding data point on the background spectrum curve is a data point having the same energy value as the initial background data point.

In some embodiments, in step 204, the intensity value of each initial background data point may be subtracted by the intensity value of the corresponding data point on the background spectrum curve. For example, the initial background data point is a data point on the background spectrum curve, so the intensity value of each target background data point may be 0.

In some embodiments, in step 205, the photoelectron spectrum data point sequence includes all the target non-background data points and all the target background data points. In some embodiments, spectrum data points (including the target background data points and the target non-background data points) in the photoelectron spectrum data point sequence are sorted in an ascending order of energy values.

Referring to FIG. 3, in some embodiments, step 201 may include, but not limited to, the following steps 301 to 302.

At 301, spectrum data points are selected from the initial photoelectron spectrum to obtain a plurality of initial spectrum data points.

At 302, each of the initial spectrum data points is divided according to a trough of the spectral line of the initial photoelectron spectrum to obtain the at least two initial background data points and the at least two initial non-background data points, where the initial background data points are located at the trough of the spectral line.

This embodiment has the following advantages. After the initial spectrum data points are obtained, the initial spectrum data points are divided according to the trough of the spectral line of the initial photoelectron spectrum to obtain initial background data points and initial non-background data points, such that subsequently the background signal can be respectively removed from the initial background data points and the initial non-background data points to obtain more accurate target background data points and target non-background data points, thereby improving the accuracy of analysis of the target photoelectron spectrum.

In some embodiments, in step 301, the initial spectrum data points may be extracted according to a preset number of data points, or the initial spectrum data points may be extracted according to special data points such as vertexes of photoelectron peaks. Other suitable method for extracting the data points may be selected according to requirements, which is not limited in the embodiments of the present disclosure.

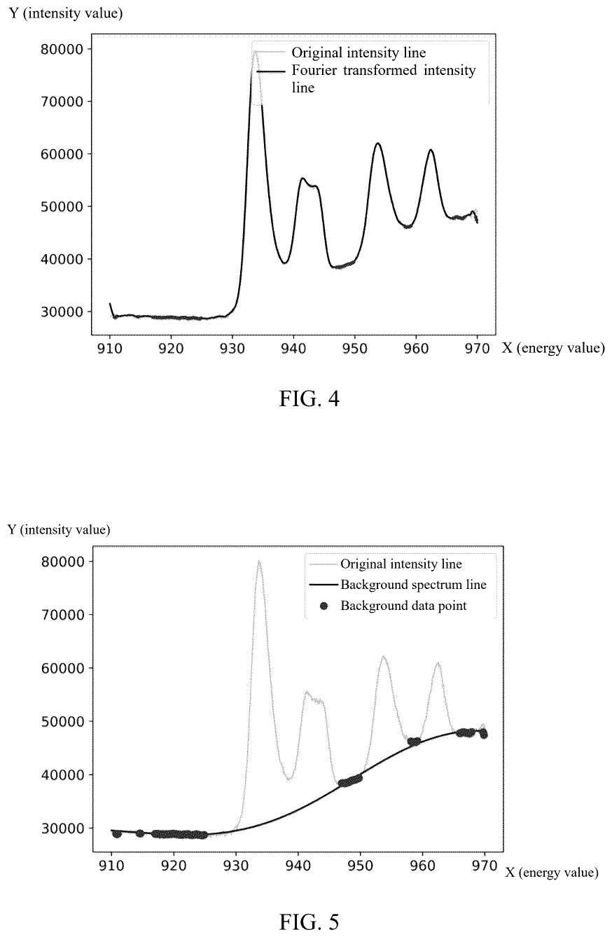

As shown in FIG. 4 and FIG. 5, in some embodiments, FIG. 4 is a schematic diagram of the initial photoelectron spectrum, which may be a 2p orbital photoelectron spectrum of divalent copper. In FIG. 4, the abscissa X represents an energy value, i.e., electron binding energy of photoelectrons, measured in eV. The ordinate Y represents an intensity value, i.e., the relative intensity of photoelectrons, which may be measured in any unit. In FIG. 4, an original intensity line is an original spectral line of the initial photoelectron spectrum; and a Fourier transformed intensity line is an intensity line obtained by performing smoothing processing on the original intensity line using a Fourier transform algorithm, thus improving the anti-interference ability of the photoelectron spectroscopy method. The spectra line of the initial photoelectron spectrum may be the original intensity line or a Fourier transformed intensity line, which is not limited herein. FIG. 5 corresponds to FIG. 4. In FIG. 5, a background spectrum curve is a curve obtained by performing Gaussian fitting according to the spectral line of the initial photoelectron spectrum (in this embodiment, the original intensity line is used as an example). A background data point is a point in an overlapping part of the background spectrum curve and the spectral line of the initial photoelectron spectrum.

In some embodiments, in step 302, it should be noted that the initial background data point is not located at the photoelectron peak. The initial background data point may be a data point located at the trough of the spectral line or a data point with a low intensity value.

In some embodiments, there are a plurality of spectrum data points (Eⱼ, I(Eⱼ)) on the spectral line of the initial photoelectron spectrum. Each of the spectrum data points (Eⱼ, I(Eⱼ)) has an energy value Eⱼ and an intensity value I(Eⱼ), where j represents a j^{th} spectrum data point, and j=1, . . . , n. On the spectral line of the initial photoelectron spectrum, m independent background intervals are defined, and then all the spectrum data points falling in the background intervals are determined as background data points. As such, all spectrum data points on the spectral line of the initial photoelectron spectrum are divided into two parts: n₁ background data points

$$( {E}_{k}^{b} , I ( {E}_{k}^{b} ) )$$

and n₂ non-background data points

$$( {E}_{l}^{n b} , I ( {E}_{l}^{n b} ) ) ,$$

where k represents a k^{th} background data point, and k=1, . . . , n₁; l represents an l^{th} non-background data point, l=1, . . . , n₂, and n₁+n₂=n.

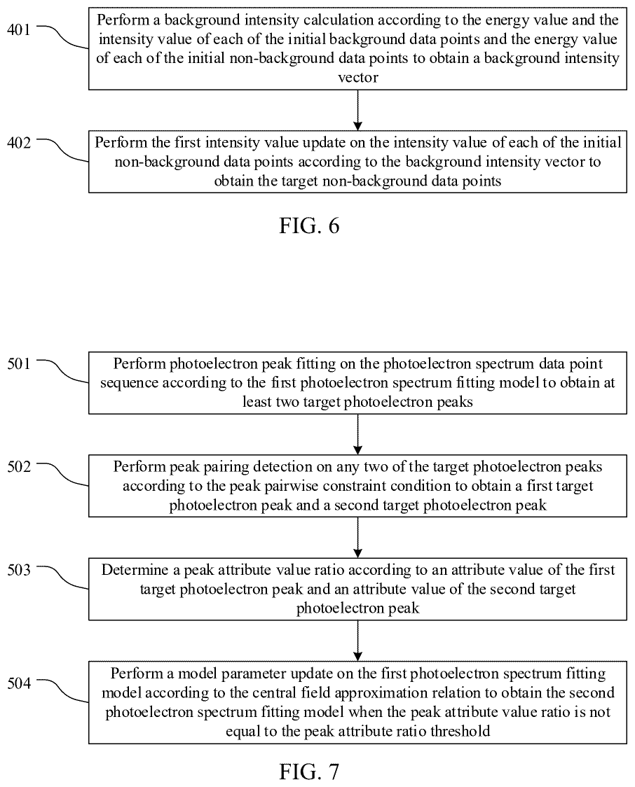

Referring to FIG. 6, in some embodiments, step 203 may include, but not limited to, the following steps 401 to 402.

At 401, a background intensity calculation is performed according to the energy value and the intensity value of each of the initial background data points and the energy value of each of the initial non-background data points to obtain a background intensity vector.

At 402, the first intensity value update is performed on the intensity value of each of the initial non-background data points according to the background intensity vector to obtain the target non-background data points.

This embodiment has the following advantage. After the background intensity vector is calculated according to the energy value and the intensity value of each initial background data point and the energy value of each initial non-background data point, the first intensity value update is performed on the intensity value of each initial non-background data point according to the background intensity vector to obtain the target non-background data points. As such, the accuracy of the target non-background data points is improved.

In some embodiments, in step 401, an initial background energy value vector X₁ is determined according to the energy values of the n₁ initial background data points, where

$${X}_{1} = ( {E}_{1}^{b} , {E}_{2}^{b} , … , {E}_{{n}_{1}}^{b} ) ;$$

an initial background intensity value vector Y₁ is determined according to the intensity values of the n₁ initial background data points, where

$${Y}_{1} = ( I ( {E}_{1}^{b} ) , I ( {E}_{2}^{b} ) , … , I ( {E}_{{n}_{1}}^{b} ) ) ;$$

an initial non-background energy value vector X₂ is determined according to the energy values of the n₂ initial non-background data points

$$( {E}_{l}^{n b} , I ( {E}_{l}^{n b} ) ) ,$$

where

$${X}_{2} = ( {E}_{1}^{n b} , {E}_{2}^{n b} , … , {E}_{{n}_{2}}^{n b} ) ;$$

and an initial non-background intensity value vector Y₂ is determined according to the intensity values of the n₂ initial non-background data points, where

$${Y}_{2} = ( I ( {E}_{1}^{n b} ) , I ( {E}_{2}^{n b} ) , … , I ( {E}_{{n}_{2}}^{n b} ) ) .$$

In other words, data points are divided into two complementary sets.

The background intensity vector μ₂ corresponding to the initial non-background energy value vector X₂ is as shown in formula (1):

$${µ}_{2} = K ( {X}_{2} , {X}_{1} ) {( K ( {X}_{1} , {X}_{1} ) + τ I )}^{- 1} {Y}_{1} ; \qquad formula ( 1 )$$

where τ is a hyperparameter, and is 0.01 by default; I represents an identity matrix; and K(⋅) represents a Gaussian kernel function. The definition of the Gaussian kernel function is as shown in formula (2):

$$K ( a , b ) = exp ( - {\vert ( a - b ) \vert}_{2}^{2} / ( 2 {σ}^{2} ) ) ; \qquad formula ( 2 )$$

where a, b represent two input variables of the Gaussian kernel function, |(a−b)|₂² represents the square of a 2-norm of (a-b), and σ represents a variable to be optimized and may be set to a fixed value of 0.01.

In some embodiments, in step 402, the intensity value of each initial non-background data point may be subtracted by a corresponding vector element in the background intensity vector to obtain the target non-background data point.

In some embodiments, after the initial non-background intensity value vector Y₂ is determined according to the intensity value of each initial non-background data point, a difference between the initial non-background intensity value vector Y₂ and the background intensity vector μ₂ is calculated to obtain a background intensity value vector

$${Y}_{2}^{′}$$

of a target interval two. In addition, (see step 203) the second intensity value update is performed on the intensity value of each initial background data point according to preset standard intensity data to obtain the corresponding target background data point, and each element of the initial background intensity value vector Y₁ may be replaced with the standard intensity data to obtain a background intensity value vector

$${Y}_{1}^{′}$$

of a target interval one. As such, two new sets of data points are obtained: a target background data point set

$$( {X}_{1} , {Y}_{1}^{′} )$$

and a target non-background data point set

$$( {X}_{2} , {Y}_{2}^{′} ) .$$

Then, (see step 204) data point integration is performed according to the target non-background data points and the target background data points to obtain the photoelectron spectrum data point sequence. For example, the target background data point set and the target non-background data point set may be joined into a photoelectron spectrum data point sequence

$$( {E}_{j}^{′} , {I ( {E}_{j} )}_{j}^{′} ) , j = 1 , ... , n$$

including n data pairs.

Referring to FIG. 7, in some embodiments, the target quantum effect constraint includes a peak pairwise constraint condition and a peak attribute ratio threshold. Step 105 may include, but not limited to, the following steps 501 to 504.

At 501, photoelectron peak fitting is performed on the photoelectron spectrum data point sequence according to the first photoelectron spectrum fitting model to obtain at least two target photoelectron peaks.

At 502, peak pairing detection is performed on any two of the target photoelectron peaks according to the peak pairwise constraint condition to obtain a first target photoelectron peak and a second target photoelectron peak.

At 503, a peak attribute value ratio is determined according to an attribute value of the first target photoelectron peak and an attribute value of the second target photoelectron peak.

At 504, a model parameter update is performed on the first photoelectron spectrum fitting model according to the central field approximation relation to obtain the second photoelectron spectrum fitting model when the peak attribute value ratio is not equal to the peak attribute ratio threshold.

This embodiment has the following advantages. After at least two target photoelectron peaks are obtained, the first target photoelectron peak and the second target photoelectron peak are obtained according to the peak pairwise constraint condition, then the peak attribute value ratio is determined, and when the peak attribute value ratio is not equal to the peak attribute ratio threshold, a model parameter update is performed on the first photoelectron spectrum fitting model according to the central field approximation relation. In this way, it is ensured that the target photoelectron spectrum obtained through fitting using the second photoelectron spectrum fitting model conforms to the target quantum effect constraint, thereby improving the reliability and authenticity of the photoelectron spectroscopy method.

It should be noted that the peak pairwise constraint condition is used for characterizing a peak attribute ratio relationship between two photoelectron peaks, and the peak attribute ratio threshold is used for characterizing a peak attribute ratio value that conforms to the theory of quantum mechanics.

In some embodiments, in step 501, the photoelectron spectrum fitting model (such as the initial photoclectron spectrum fitting model, the first photoelectron spectrum fitting model, and the second photoelectron spectrum fitting model) has a photoelectron peak fitting function and a spectrum fitting function. Photoelectron peak fitting may be performed on the photoelectron spectrum data point sequence according to the photoelectron peak fitting function of the first photoelectron spectrum fitting model to obtain at least two target photoelectron peaks. Then, spectrum fitting may be performed on the target photoelectron peaks according to the spectrum fitting function to obtain a corresponding photoelectron spectrum.

In some embodiments, the photoelectron peak fitting function is as shown in formula (3), and the spectrum fitting function is as shown in formula (4):

$${y}_{i} ( x ) = {Δ}_{i} \cdot \frac{1}{π} [ \frac{{γ}_{i}}{{( x - {μ}_{i} )}^{2} + {γ}_{i}^{2}} ] + ( 1 - {Δ}_{i} ) \cdot \frac{1}{\sqrt{2 π} {σ}_{i}} exp ( - \frac{{( x - {μ}_{i} )}^{2}}{2 {σ}_{i}^{2}} ) ; \qquad formula ( 3 )$$

$${y}^{cal} = {\sum }_{i = 1}^{p} {w}_{i} {y}_{i} ( x ) ; \qquad formula ( 4 )$$

where yᵢ(x) represents an i^{th} photoelectron peak; x represents an independent variable of a function yᵢ(x), where x may be set to an energy value of any spectrum data point according to requirements, for example, an energy value

$${E}_{k}^{b}$$

of an initial background data point or an energy value

$${E}_{l}^{nb}$$

of an initial non-background data point; (wᵢ, Δᵢ, μᵢ, γᵢ, σᵢ) represent parameters of the photoelectron peak yᵢ(x), i.e., model parameters of the photoelectron spectrum fitting models, where i represents the i^{th} photoelectron peak, and i=1, 2, . . . , p; p represents the total number of photoelectron peaks; corresponding to the i^{th} photoelectron peak, wᵢ represents a first peak intensity parameter, Δᵢ represents a second peak intensity parameter, μᵢ represents a peak position parameter, γᵢ represents a first peak shape parameter, and σᵢ represents a second peak shape parameter; and y^{cal} represents a photoelectron spectrum (such as the initial photoelectron spectrum and the target photoelectron spectrum) output from the photoelectron spectrum fitting model.

In some embodiments, performing the first model parameter update according to the preset expectation-maximization algorithm refers to defining an iterative update strategy for model parameters based on the expectation-maximization algorithm, i.e., model parameters at step (t) are given, model parameters at step (t+1) are obtained by an iteration method. To be specific, starting from t being 0, when t=0, initial values of the model parameters are

$$( {w}_{i}^{( 0 )} , {Δ}_{i}^{( 0 )} , {μ}_{i}^{( 0 )} , {γ}_{i}^{( 0 )} , {σ}_{i}^{( 0 )} ) ,$$

where i=1, 2, . . . , p. When t>0, the model parameters are updated according to formulas (5) to (9):

$${w}_{i}^{( temp , t + 1 )} = {I}_{area} \cdot \frac{{\sum }_{j = 1}^{n} ( {I}^{′} ( x ) {ji}_{( t )}^{} )}{{\sum }_{j = 1}^{n} {I}^{′} ( x )} ; \qquad formula ( 5 )$$

$${μ}_{i}^{( temp , t + 1 )} = \frac{\begin{matrix}\frac{2 π}{{γ}_{i}^{( t )}} {\sum }_{j = 1}^{n} {I}^{′} ( x ) \cdot {β}_{ji}^{{L}^{( t )}} \cdot ( x ) + \\ \frac{1}{{σ}_{i}^{{2}^{( t )}}} {\sum }_{j = 1}^{n} {I}^{′} ( x ) \cdot {ji}_{{R}^{( t )}}^{} \cdot ( x )\end{matrix}}{\frac{2 π}{{γ}_{i}^{( t )}} {\sum }_{j = 1}^{n} {I}^{′} ( x ) \cdot {β}_{ji}^{{L}^{( t )}} + \frac{1}{{σ}_{i}^{{2}^{( t )}}} {\sum }_{j = 1}^{n} {I}^{′} ( x ) \cdot {ji}_{{R}^{( t )}}^{}} ; \qquad formula ( 6 )$$

$${γ}_{i}^{( t + 1 )} = {[ \frac{{\sum }_{j = 1}^{n} {I}^{′} ( x ) \cdot {β}_{ji}^{{L}^{( t )}} \cdot {( x - {μ}_{i}^{( t )} )}^{2}}{{\sum }_{j = 1}^{n} {I}^{′} ( x ) \cdot {β}_{ji}^{{L}^{( t )}}} ]}^{\frac{1}{2}} ; \qquad formula ( 7 )$$

$${σ}_{i}^{{2}^{( t + 1 )}} = \frac{{\sum }_{j = 1}^{n} {I}^{′} ( x ) \cdot {ji}_{{R}^{( t )}}^{} \cdot {( x - {μ}_{i}^{( t )} )}^{2}}{{\sum }_{j = 1}^{n} {I}^{′} ( x ) \cdot {ji}_{{R}^{( t )}}^{}} ; \qquad formula ( 8 )$$

$${Δ}_{i}^{( t + 1 )} = \frac{{\sum }_{j = 1}^{n} {I}^{′} ( x ) \cdot {ji}_{{L}^{( t )}}^{}}{{\sum }_{j = 1}^{n} {I}^{′} ( x ) \cdot {{ji}_{( t )}^{}}^{( t )}} . \qquad formula ( 9 )$$

The definitions of

$$, , and {β}_{ji}^{{L}^{( t )}}$$

are as shown in formulas (10) to (12):

$$= \frac{{w}_{i}^{( t )} \cdot \frac{{Δ}_{i}^{( t )}}{π} [ \frac{{γ}_{i}^{( t )}}{{( x - {μ}_{i}^{( t )} )}^{2} + {( {γ}_{i}^{( t )} )}^{2}} ]}{\begin{matrix}{\sum }_{i = 1}^{m} {w}_{i}^{( t )} \cdot ( \frac{{Δ}_{i}^{( t )}}{π} [ \frac{{γ}_{i}^{( t )}}{{( x - {μ}_{i}^{( t )} )}^{2} + {( {γ}_{i}^{( t )} )}^{2}} ] + \\ \frac{1 - {Δ}_{i}^{( t )}}{\sqrt{2 {πσ}^{{2}_{i}^{( t )}}}} exp ( - \frac{{( x - {μ}_{i}^{( t )} )}^{2}}{2 {σ}^{{2}_{i}^{( t )}}} ) )\end{matrix}} ; \qquad formula ( 10 )$$

$$= \frac{{w}_{i}^{( t )} \cdot \frac{1 - {Δ}_{i}^{( t )}}{\sqrt{2 {πσ}^{{2}_{i}^{( t )}}}} exp ( - \frac{{( x - {μ}_{i}^{( t )} )}^{2}}{2 {σ}^{{2}_{i}^{( t )}}} )}{\begin{matrix}{\sum }_{i = 1}^{m} {w}_{i}^{( t )} \cdot ( \frac{{Δ}_{i}^{( t )}}{π} [ \frac{{γ}_{i}^{( t )}}{{( x - {μ}_{i}^{( t )} )}^{2} + {( {γ}_{i}^{( t )} )}^{2}} ] + \\ \frac{1 - {Δ}_{i}^{( t )}}{\sqrt{2 {πσ}^{{2}_{i}^{( t )}}}} exp ( - \frac{{( x - {μ}_{i}^{( t )} )}^{2}}{2 {σ}^{{2}_{i}^{( t )}}} )\end{matrix}} ; \qquad formula ( 11 )$$

$${β}_{ji}^{{L}^{( t )}} = \cdot \frac{{γ}_{i}^{( t )}}{π [ {( x - {μ}_{i}^{( t )} )}^{2} + {( {γ}_{i}^{( t )} )}^{2} ]} ; \qquad formula ( 12 )$$

where x represents experimental data with the background signal removed, i.e., intensity values

$${E}_{j}^{′} , j = 1 , ... , n$$

or the photoelectron spectrum data point sequence. It should be noted that parameters

$$( such as , , {β}_{ji}^{{L}^{( t )}} , etc . )$$

in the formulas (5) to (12) other than the model parameters are all intermediate parameters or preset parameters, and may be initialized according to requirements, which is not particularly limited in the embodiments of the present disclosure.

With the model parameters

$$( {w}_{i}^{( t )} , {Δ}_{i}^{( t )} , {μ}_{i}^{( t )} , {γ}_{i}^{( t )} , {σ}_{i}^{( t )} )$$

at step (t), model parameters

$$( {w}_{i}^{( temp , t + 1 )} , {Δ}_{i}^{( t + 1 )} , {μ}_{i}^{( temp , t + 1 )} , {γ}_{i}^{( t + 1 )} , {σ}^{{2}_{i}^{( t + 1 )}} )$$

at step (t+1) can be obtained according to formulas (5) to (9). The obtained model parameters can be substituted into formula (3) to obtain the i^{th} photoelectron peak function at step (t+1), and substituted into formula (4) to obtain a theoretical photoelectron spectrum at step (t+1).

It should be noted that split peaks are a pair of photoelectron peaks caused by the spin-orbit coupling of electrons. Satellite peaks are photoelectron peaks caused by various excitation states of the final state effect. The excitation states may include multiplet splitting, electron shake-up and shake-off, etc. The final state effect refers to the energy change and impact produced when photoelectrons escape from the nucleus and escape from the surface during the photoemission process.

In some embodiments, in step 502, the peak pairwise constraint condition includes at least one of a split peak constraint condition and a satellite peak constraint condition, and the peak attribute ratio threshold includes at least one of a peak intensity ratio threshold and a peak area ratio threshold. In an embodiment, step 502 includes: performing split peak pairing detection on any two of the target photoelectron peaks according to the split peak constraint condition to obtain a first target split peak and a second target split peak. The split peak constraint condition is used for characterizing that elements to which the two target photoelectron peaks belong are the same element with the same valence state, and have the same principal quantum number and angular quantum number. In another embodiment, step 502 further includes: performing satellite peak pairing detection on any two of the target photoelectron peaks according to the satellite peak constraint condition to obtain a first target satellite peak and a second target satellite peak. The satellite peak constraint condition is used for characterizing that elements to which the two target photoelectron peaks belong are the same element with the same valence state, and have the same principal quantum number and total angular quantum number. It should be noted that the principal quantum number, the angular quantum number, and the total angular quantum number of any target photoelectron peak may be acquired from a preset photoelectron peak database. An element to which any target photoelectron peak belongs and an initial value of a valence state of the element may be determined by table look-up.

In some embodiments, in step 503, attribute values include a peak intensity and a peak area, and peak attribute value ratios include a peak intensity ratio and a peak area ratio. In an embodiment, after the first target split peak and the second target split peak are obtained, step 503 includes: determining the peak intensity ratio according to a peak intensity of the first target split peak and a peak intensity of the second target split peak. In another embodiment, after the first target satellite peak and the second target satellite peak are obtained, step 503 further includes: determining the peak area ratio according to a peak area of the first target satellite peak and a peak area of the second target satellite peak.

In some embodiments, in step 504, the central field approximation relation includes at least one of a central field approximation split peak relation and a central field approximation satellite peak relation. In an embodiment, after the peak intensity ratio is determined, step 504 includes: performing a model parameter update on the first photoelectron spectrum fitting model according to the central field approximation split peak relation to obtain the second photoelectron spectrum fitting model when the peak intensity ratio is not equal to the peak intensity ratio threshold. In another embodiment, after the peak area ratio is determined, step 504 further includes: performing a model parameter update on the first photoelectron spectrum fitting model according to the central field approximation satellite peak relation to obtain the second photoelectron spectrum fitting model when the peak area ratio is not equal to the peak area ratio threshold. Alternatively, a model parameter update may be performed on the second photoelectron spectrum fitting model according to the central field approximation satellite peak relation to obtain an updated second photoelectron spectrum fitting model.

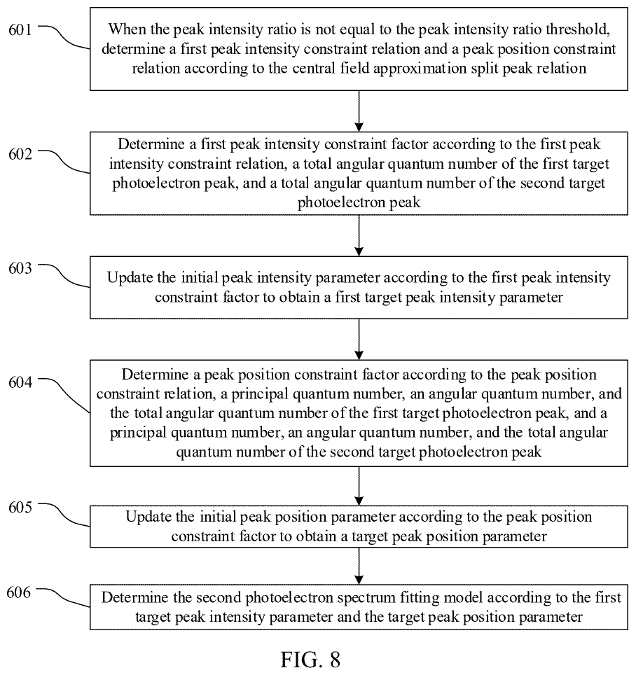

Referring to FIG. 8, in some embodiments, model parameters of the first photoelectron spectrum fitting model include an initial peak intensity parameter and an initial peak position parameter; and the peak attribute value ratio includes a peak intensity ratio, the peak attribute ratio threshold includes a peak intensity ratio threshold, and the central field approximation relation includes a central field approximation split peak relation. Step 504 may include, but not limited to, the following steps 601 to 606.

At 601, when the peak intensity ratio is not equal to the peak intensity ratio threshold, a first peak intensity constraint relation and a peak position constraint relation are determined according to the central field approximation split peak relation.

At 602, a first peak intensity constraint factor is determined according to the first peak intensity constraint relation, a total angular quantum number of the first target photoelectron peak, and a total angular quantum number of the second target photoelectron peak.

At 603, the initial peak intensity parameter is updated according to the first peak intensity constraint factor to obtain a first target peak intensity parameter.

At 604, a peak position constraint factor is determined according to the peak position constraint relation, a principal quantum number, an angular quantum number, and the total angular quantum number of the first target photoelectron peak, and a principal quantum number, an angular quantum number, and the total angular quantum number of the second target photoelectron peak.

At 605, the initial peak position parameter is updated according to the peak position constraint factor to obtain a target peak position parameter.

At 606, the second photoelectron spectrum fitting model is determined according to the first target peak intensity parameter and the target peak position parameter.

This embodiment has the following advantages. The first peak intensity constraint relation and the peak position constraint relation are determined according to the central field approximation split peak relation, the initial peak intensity parameter is updated according to the first peak intensity constraint factor, and the peak position constraint factor is determined according to the peak position constraint relation. Then, the initial peak intensity parameter is updated according to the first peak intensity constraint factor to obtain the first target peak intensity parameter, and the initial peak position parameter is updated according to the peak position constraint factor to obtain the target peak position parameter. In this way, it is ensured that the target photoelectron spectrum output by the second photoelectron spectrum fitting model conforms to a relevant constraint of split peaks, i.e., the peak intensity ratio of any pair of split peaks in the target photoelectron spectrum is equal to the peak intensity ratio threshold, thereby improving the authenticity of the spectrum analysis result.

It should be noted that the initial peak intensity parameter is the first peak intensity parameter wᵢ in formula (4). The initial peak position parameter is the peak position parameter μᵢ in formula (3).

In some embodiments, in step 601, the central field approximation split peak relation includes a first peak intensity constraint relation and a peak position constraint relation.

In some embodiments, in step 602, the definition of the first peak intensity constraint factor is as shown in formula (13):

$$R = \frac{2 {J}_{1} + 1}{2 {J}_{2} + 1} ; \qquad formula ( 13 )$$

where R represents the first peak intensity constraint factor, J₁ represents a total angular quantum number of the first target photoelectron peak, and J₂ represents a total angular quantum number of the second target photoelectron peak. Formula (13) is the first peak intensity constraint relation.

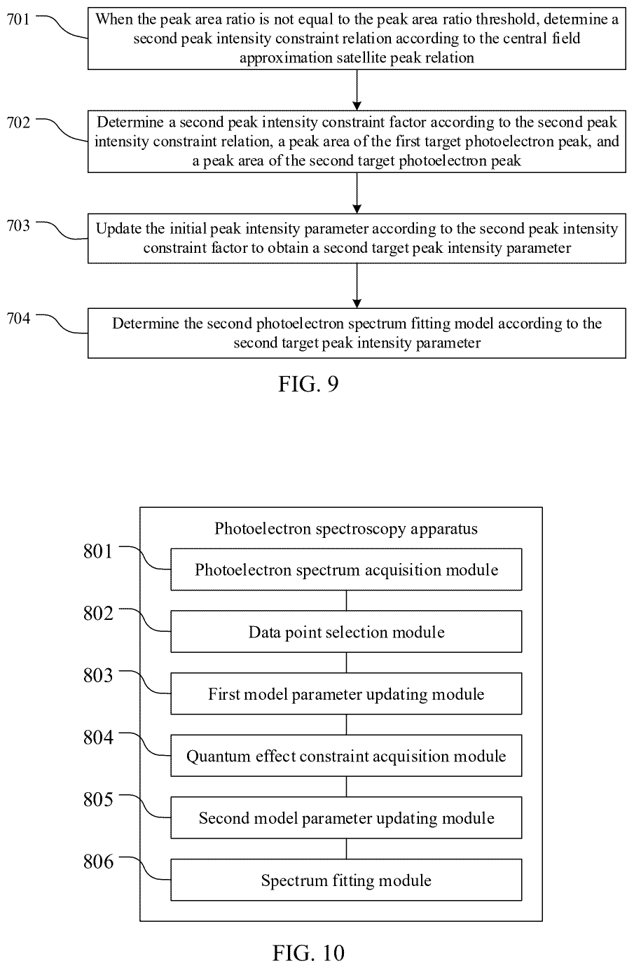

Referring to FIG. 9, in some embodiments, model parameters of the first photoelectron spectrum fitting model include an initial peak intensity parameter; and the peak attribute value ratio further includes a peak area ratio, the peak pairwise constraint condition further includes a satellite peak constraint condition, the peak attribute ratio threshold further includes a peak area ratio threshold, and the central field approximation relation further includes a central field approximation satellite peak relation. Step 504 may further include, but not limited to, the following steps 701 to 704.

At 701, when the peak area ratio is not equal to the peak area ratio threshold, a second peak intensity constraint relation is determined according to the central field approximation satellite peak relation.

At 702, a second peak intensity constraint factor is determined according to the second peak intensity constraint relation, a peak area of the first target photoelectron peak, and a peak area of the second target photoelectron peak.

At 703, the initial peak intensity parameter is updated according to the second peak intensity constraint factor to obtain a second target peak intensity parameter.

At 704, the second photoelectron spectrum fitting model is determined according to the second target peak intensity parameter.

This embodiment has the following advantages. The second peak intensity constraint factor is determined according to the second peak intensity constraint relation, the peak area of the first target photoelectron peak, and the peak area of the second target photoelectron peak. Then, the second target peak intensity parameter is determined according to the second peak intensity constraint factor. In this way, it is ensured that the target photoelectron spectrum output by the second photoelectron spectrum fitting model conforms to a relevant constraint of satellite peaks, i.e., the peak area ratio of any pair of satellite peaks in the target photoelectron spectrum is equal to the peak area ratio threshold, thereby improving the authenticity of the spectrum analysis result.

In some embodiments, in step 702, the first target photoelectron peak includes a first target satellite peak and a second target satellite peak, which are a pair of satellite peaks. The second target photoelectron peak includes a third target satellite peak and a fourth target satellite peak, which are a pair of satellite peaks. The second peak intensity constraint factor may be determined according to the second peak intensity constraint relation, the peak area of the first target photoelectron peak, and the peak area of the second target photoelectron peak. The definition of the second peak intensity constraint factor is as shown in formula (14):

$$SA = 0.5 \times ( \frac{{A}_{sl 1 sp}}{{A}_{sl 1}} + \frac{{A}_{sl 2 sp}}{{A}_{sl 2}} ) ; \qquad formula ( 14 )$$

where SA represents the second peak intensity constraint factor, Aₛₗ₁ represents a peak area of the first target satellite peak, Aₛₗ₁ₛₚ represents a peak area of the second target satellite peak, Aₛₗ₂ represents a peak area of the third target satellite peak, and Aₛₗ₂ₛₚ represents a peak area of the fourth target satellite peak. Formula (14) is the second peak intensity constraint relation.

Referring to FIG. 10, an embodiment of the present disclosure provides a photoelectron spectroscopy apparatus capable of implementing the above photoelectron spectroscopy method. The apparatus includes:
a photoelectron spectrum acquisition module 801, configured for performing photoelectron spectrum detection on a target sample to obtain an initial photoelectron spectrum;
a data point selection module 802, configured for selecting spectrum data points according to the initial photoelectron spectrum to obtain a photoelectron spectrum data point sequence;
a first model parameter updating module 803, configured for performing a first model parameter update on a preset initial photoelectron spectrum fitting model according to a preset expectation-maximization algorithm and the photoelectron spectrum data point sequence to obtain a first photoelectron spectrum fitting model;
a quantum effect constraint acquisition module 804, configured for acquiring a target quantum effect constraint for the target sample;
a second model parameter updating module 805, configured for performing a second model parameter update on the first photoelectron spectrum fitting model according to a preset central field approximation relation and the target quantum effect constraint to obtain a second photoelectron spectrum fitting model; and
a spectrum fitting module 806, configured for performing spectrum fitting on the photoelectron spectrum data point sequence according to the second photoelectron spectrum fitting model to obtain a target photoelectron spectrum.

Specific embodiments of the photoelectron spectroscopy apparatus are basically the same as the specific embodiments of the photoelectron spectroscopy method, so the details will not be repeated herein.

An embodiment of the present disclosure provides an electronic device, including a memory and a processor. The memory is configured for storing a computer program which, when executed by the processor, causes the processor to implement the photoelectron spectroscopy method described above. The electronic device may include any smart terminal device such as a tablet computer or an in-vehicle computer.

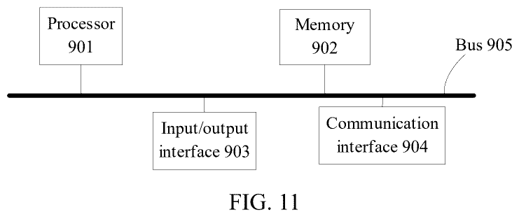

FIG. 11 shows a hardware structure of an electronic device according to another embodiment. Referring to FIG. 11, the electronic device includes a processor 901, a memory 902, an input/output interface 903, a communication interface 904, and a bus 905.

The processor 901 may be implemented by a general-purpose Central Processing Unit (CPU), a microprocessor, an Application Specific Integrated Circuit (ASIC), or one or more integrated circuits, and is configured for executing a related program to implement the technical schemes provided by the embodiments of the present disclosure.

The memory 902 may be implemented in the form of a Read-Only Memory (ROM), a static storage device, a dynamic storage device, a Random Access Memory (RAM), etc. The memory 902 may store an operating system and other application programs. When the technical schemes provided by the embodiments of the present disclosure are implemented by software or firmware, related program code is stored in the memory 902 which, when called by the processor 901, causes the processor 901 to implement the photoelectron spectroscopy method according to the embodiments of the present disclosure.

The input/output interface 903 is configured for enabling input and output of information.

The communication interface 904 is configured for realizing communication interaction between the electronic device and other devices, either through wired communication (e.g., USB, network cable, etc.) or through wireless communication (e.g., mobile network, Wi-Fi, Bluetooth, etc.).

The bus 905 is configured for transmitting information between components of the electronic device (such as the processor 901, the memory 902, the input/output interface 903, and the communication interface 904).

The processor 901, the memory 902, the input/output interface 903, and the communication interface 904 are in communication connection with each other inside the electronic device through the bus 905.

An embodiment of the present disclosure provides a computer-readable storage medium, storing a computer program which, when executed by a processor, causes the processor to implement the photoelectron spectroscopy method described above.

The memory, as a non-transitory computer-readable storage medium, may be configured for storing a non-transitory software program and a non-transitory computer-executable program. In addition, the memory may include a high-speed random access memory, and may also include a non-transitory memory, e.g., at least one magnetic disk storage device, flash memory device, or other non-transitory solid-state storage device. In some implementations, the memory may include memories located remotely from the processor, and the remote memories may be connected to the processor via a network. Examples of the network include, but not limited to, the Internet, an intranet, a local area network, a mobile communication network, and combinations thereof.

The contents described in the embodiments of the present disclosure are for the purpose of illustrating the technical schemes of the embodiments of the present disclosure more clearly, and do not constitute a limitation to the technical schemes provided in the embodiments of the present disclosure. Those having ordinary skills in the art may know that with the evolution of technologies and the emergence of new application scenarios, the technical schemes provided in the embodiments of the present disclosure are also applicable to similar technical problems.

Those having ordinary skills in the art may understand that the technical scheme shown in FIG. 2 does not constitute a limitation to the embodiments of the present disclosure, and more or fewer steps than those shown in the figure may be included, or some steps may be combined, or different steps may be used.

The apparatus embodiments described above are merely examples. The units described as separate components may or may not be physically separated, i.e., they may be located in one place or may be distributed over a plurality of network units. Some or all of the modules may be selected according to actual needs to achieve the objectives of the scheme of this embodiment.

Those having ordinary skills in the art can understand that all or some of the steps in the methods disclosed above and the functional modules/units in the system and the apparatus can be implemented as software, firmware, hardware, and appropriate combinations thereof.

In the description and accompanying drawings of the present disclosure, the terms “first”, “second”, “third”, “fourth”, and so on (if any) are intended to distinguish between similar objects but do not necessarily indicate a specific sequence or a precedence order. It is to be understood that the data termed in such a way are interchangeable in appropriate circumstances, such that the embodiments of the present disclosure described herein can be implemented in orders other than the order shown or described herein. Moreover, the terms “include,” “comprise,” and any other variants thereof are intended to cover a non-exclusive inclusion. For example, a process, method, system, product, or device that includes a list of steps or units is not necessarily limited to those expressly listed steps or units, but may include other steps or units not expressly listed or inherent to such a process, method, product, or device.

It is to be understood that in the present disclosure, “at least one” means one or more and “a plurality of” means two or more. The term “and/or” is used for describing an association between associated objects and representing that three associations may exist. For example, “A and/or B” may indicate that only A exists, only B exists, and both A and B exist, where A and B may be singular or plural. The character “/” generally indicates an “or” relation between the associated objects. “At least one of” and similar expressions refer to any combination of items listed, including one item or any combination of a plurality of items. For example, at least one of a, b, or c may represent a, b, c, “a and b”, “a and c”, “b and c”, or “a, b, and c”, where a, b, and c may be singular or plural.

In the several embodiments provided in the present disclosure, it is to be understood that the disclosed apparatus and method may be implemented in other manners. For example, the described apparatus embodiments are only exemplary. For example, the division of the units is merely a logical function division and other division manners may be used in practical implementations. For example, a plurality of units or components may be combined or integrated into another system, or some features may be ignored or not performed. The shown or discussed mutual couplings or direct couplings or communication connections may be implemented through some interfaces. The indirect couplings or communication connections between the apparatus or units may be implemented in electronic, mechanical, or other forms.

The units described as separate parts may or may not be physically separate. Parts displayed as units may or may not be physical units, and may be located in one place, or may be distributed on a plurality of network units. Some or all of the units may be selected according to actual needs to achieve the objectives of the scheme of this embodiment.

In addition, functional units in the embodiments of the present disclosure may be integrated into one processing unit, or each of the units may exist alone physically, or two or more units may be integrated into one unit. The integrated unit may be implemented in the form of hardware, or may be implemented in the form of a software functional unit.

The integrated unit may be stored in a computer-readable storage medium if implemented in the form of a software functional unit and sold or used as an independent product. Based on such an understanding, the technical schemes of the present disclosure essentially, or the part contributing to the related art, or all or some of the technical schemes may be implemented in the form of a software product. The software product is stored in a storage medium, and includes several instructions for instructing a computer device (which may be a personal computer, a server, a network device, or the like) to execute all or some of the steps of the methods described in the embodiments of the present disclosure. The foregoing storage medium includes: any medium that can store program code, such as a USB flash drive, a removable hard disk, a ROM, a RAM, a magnetic disk, or an optical disk.

Although some embodiments of the present disclosure are described above with reference to the accompanying drawings, these embodiments are not intended to limit the protection scope of the embodiments of the present disclosure. Any modifications, equivalent replacements and improvements made by those having ordinary skills in the art without departing from the scope and essence of the embodiments of the present disclosure shall fall within the protection scope of the embodiments of the present disclosure.

What is claimed is:

1. A photoelectron spectroscopy method, comprising:
performing photoelectron spectrum detection on a target sample to obtain an initial photoelectron spectrum;
selecting spectrum data points according to the initial photoelectron spectrum to obtain a photoelectron spectrum data point sequence;
performing a first model parameter update on a preset initial photoelectron spectrum fitting model according to a preset expectation-maximization algorithm and the photoelectron spectrum data point sequence to obtain a first photoelectron spectrum fitting model;
acquiring a target quantum effect constraint for the target sample;
performing a second model parameter update on the first photoelectron spectrum fitting model according to a preset central field approximation relation and the target quantum effect constraint to obtain a second photoelectron spectrum fitting model; and
performing spectrum fitting on the photoelectron spectrum data point sequence according to the second photoelectron spectrum fitting model to obtain a target photoelectron spectrum.

2. The photoelectron spectroscopy method of claim 1, wherein the target quantum effect constraint comprises a peak pairwise constraint condition and a peak attribute ratio threshold; and
performing a second model parameter update on the first photoelectron spectrum fitting model according to a preset central field approximation relation and the target quantum effect constraint to obtain a second photoelectron spectrum fitting model comprises:
performing photoelectron peak fitting on the photoelectron spectrum data point sequence according to the first photoelectron spectrum fitting model to obtain at least two target photoelectron peaks;
performing peak pairing detection on any two of the target photoelectron peaks according to the peak pairwise constraint condition to obtain a first target photoelectron peak and a second target photoelectron peak;
determining a peak attribute value ratio according to an attribute value of the first target photoelectron peak and an attribute value of the second target photoelectron peak; and
performing a model parameter update on the first photoelectron spectrum fitting model according to the central field approximation relation to obtain the second photoelectron spectrum fitting model in response to the peak attribute value ratio being not equal to the peak attribute ratio threshold.

3. The photoelectron spectroscopy method of claim 2, wherein model parameters of the first photoelectron spectrum fitting model comprise an initial peak intensity parameter and an initial peak position parameter; the peak attribute value ratio comprises a peak intensity ratio, the peak attribute ratio threshold comprises a peak intensity ratio threshold, and the central field approximation relation comprises a central field approximation split peak relation; and
performing a model parameter update on the first photoelectron spectrum fitting model according to the central field approximation relation to obtain the second photoelectron spectrum fitting model in response to the peak attribute value ratio being not equal to the peak attribute ratio threshold comprises:
in response to the peak intensity ratio being not equal to the peak intensity ratio threshold, determining a first peak intensity constraint relation and a peak position constraint relation according to the central field approximation split peak relation;
determining a first peak intensity constraint factor according to the first peak intensity constraint relation, a total angular quantum number of the first target photoelectron peak, and a total angular quantum number of the second target photoelectron peak;
updating the initial peak intensity parameter according to the first peak intensity constraint factor to obtain a first target peak intensity parameter;
determining a peak position constraint factor according to the peak position constraint relation, a principal quantum number, an angular quantum number, and the total angular quantum number of the first target photoelectron peak, and a principal quantum number, an angular quantum number, and the total angular quantum number of the second target photoelectron peak;
updating the initial peak position parameter according to the peak position constraint factor to obtain a target peak position parameter; and
determining the second photoelectron spectrum fitting model according to the first target peak intensity parameter and the target peak position parameter.

4. The photoelectron spectroscopy method of claim 2, wherein model parameters of the first photoelectron spectrum fitting model comprise an initial peak intensity parameter; the peak attribute value ratio further comprises a peak area ratio, the peak pairwise constraint condition further comprises a satellite peak constraint condition, the peak attribute ratio threshold further comprises a peak area ratio threshold, and the central field approximation relation further comprises a central field approximation satellite peak relation; and
performing a model parameter update on the first photoelectron spectrum fitting model according to the central field approximation relation to obtain the second photoelectron spectrum fitting model in response to the peak attribute value ratio being not equal to the peak attribute ratio threshold further comprises:
in response to the peak area ratio being not equal to the peak area ratio threshold, determining a second peak intensity constraint relation according to the central field approximation satellite peak relation;
determining a second peak intensity constraint factor according to the second peak intensity constraint relation, a peak area of the first target photoelectron peak, and a peak area of the second target photoelectron peak;
updating the initial peak intensity parameter according to the second peak intensity constraint factor to obtain a second target peak intensity parameter; and
determining the second photoelectron spectrum fitting model according to the second target peak intensity parameter.

5. The photoelectron spectroscopy method of claim 1, wherein the initial photoelectron spectrum has initial photoelectron peaks; and selecting spectrum data points according to the initial photoelectron spectrum to obtain a photoelectron spectrum data point sequence comprises:
dividing spectrum data points according to a spectral line of the initial photoelectron spectrum to obtain at least two initial background data points and at least two initial non-background data points, wherein each of the initial background data points and each of the initial non-background data points has an energy value and an intensity value;
performing background spectrum curve fitting on at least two of the initial background data points according to a preset Gaussian random process function to obtain a background spectrum curve;
performing a first intensity value update on the intensity value of each of the initial non-background data points according to the energy value and the intensity value of each of the initial background data points and the energy value of each of the initial non-background data points to obtain corresponding target non-background data points;
performing a second intensity value update on the intensity value of each of the initial background data points according to the background spectrum curve to obtain corresponding target background data points, wherein an intensity value of each of the target background data point is less than an intensity value of the respective initial background data point; and
performing data point integration according to the target non-background data points and the target background data points to obtain the photoelectron spectrum data point sequence.

6. The photoelectron spectroscopy method of claim 5, wherein performing a first intensity value update on the intensity value of each of the initial non-background data points according to the energy value and the intensity value of each of the initial background data points and the energy value of each of the initial non-background data points to obtain corresponding target non-background data points comprises:
performing a background intensity calculation according to the energy value and the intensity value of each of the initial background data points and the energy value of each of the initial non-background data points to obtain a background intensity vector; and
performing the first intensity value update on the intensity value of each of the initial non-background data points according to the background intensity vector to obtain the target non-background data points.

7. The photoelectron spectroscopy method of claim 5, wherein dividing spectrum data points according to a spectral line of the initial photoelectron spectrum to obtain at least two initial background data points and at least two initial non-background data points comprises:
selecting spectrum data points from the initial photoelectron spectrum to obtain a plurality of initial spectrum data points; and
dividing each of the initial spectrum data points according to a trough of the spectral line of the initial photoelectron spectrum to obtain the at least two initial background data points and the at least two initial non-background data points, wherein the initial background data points are located at the trough of the spectral line.

8. A photoelectron spectroscopy apparatus, comprising:
a photoelectron spectrum acquisition module, configured for performing photoelectron spectrum detection on a target sample to obtain an initial photoelectron spectrum;
a data point selection module, configured for selecting spectrum data points according to the initial photoelectron spectrum to obtain a photoelectron spectrum data point sequence;
a first model parameter updating module, configured for performing a first model parameter update on a preset initial photoelectron spectrum fitting model according to a preset expectation-maximization algorithm and the photoelectron spectrum data point sequence to obtain a first photoelectron spectrum fitting model;
a quantum effect constraint acquisition module, configured for acquiring a target quantum effect constraint for the target sample;
a second model parameter updating module, configured for performing a second model parameter update on the first photoelectron spectrum fitting model according to a preset central field approximation relation and the target quantum effect constraint to obtain a second photoelectron spectrum fitting model; and
a spectrum fitting module, configured for performing spectrum fitting on the photoelectron spectrum data point sequence according to the second photoelectron spectrum fitting model to obtain a target photoelectron spectrum.

9. An electronic device, comprising a memory and a processor, wherein the memory is configured for storing a computer program which, when executed by the processor, causes the processor to perform the photoelectron spectroscopy method of claim 1.

10. A non-transitory computer-readable storage medium, storing a computer program which, when executed by a processor, causes the processor to perform the photoelectron spectroscopy method of claim 1.
